(19) United States
(12) Patent Application Publication
(10) Pub. No.: US 2019/0187542 A1
(43) Pub. Date: Jun. 20, 2019

(54) PROJECTOR

(71) Applicant: SEIKO EPSON CORPORATION, Tokyo (JP)

(72) Inventors: Norikazu Kadotani, Azumino-shi (JP); Yoshiaki Iwatani, Azumino-shi (JP)

(73) Assignee: SEIKO EPSON CORPORATION, Tokyo (JP)

(21) Appl. No.: 16/218,561

(22) Filed: Dec. 13, 2018

(30) Foreign Application Priority Data
Dec. 14, 2017 (JP) 2017-239344

(51) Int. Cl. G03B 21/16; F21V 8/00; G03B 21/00

(52) U.S. Cl. CPC G03B 21/16; G03B 21/006; G02B 6/0056

(57) ABSTRACT

A projector includes an optical element (e.g., liquid crystal panels as light modulation element) as a cooling target, a blast fan (a suction fan) adapted to feed air (outside air) for cooling, a duct adapted to make the air by the blast fan flow, and having an exhaust port (ejection ports) opposed to the optical element, and a furry member provided to an inside wall of the duct.

### BACKGROUND

### 1. Technical Field

The present invention relates to a projector.

### 2. Related Art

In the past, in the case of cooling an optical component which generates heat such as a light modulation element and a polarization conversion element for constituting a projector, the cooling is performed by making the outside air flow in a duct with a fan to thereby eject the outside air toward the optical component which generates heat. On this occasion, the wind noise of the outside air flowing in the duct and so on is the factors of increasing the noise of the projector. In recent years, since the noise is further increased due to the fact that an increase in luminance of the projector progresses to increase an amount of heat generation of the optical component and so on, noise reduction of the projector is strongly demanded.

In JP-A-2001-68882 (Document 1), there is disclosed the fact that a sound absorbing material is disposed in the duct to thereby reduce the noise.

However, in Document 1, there is described the fact that the sound absorbing material is disposed in the duct, but the details of the sound absorbing material, an effective installation place of the sound absorbing material in the duct and so on are not disclosed. Therefore, there has been demanded the projector capable of effectively achieving the noise reduction of the duct.

### SUMMARY

An advantage of some aspects of the invention is to solve at least a part of the problems described above, and the invention can be implemented as the following aspects or application examples.

### Application Example 1

A projector according to this application example is a projector adapted to modulate light emitted from a light source based on image information and project the light modulated, including an optical element as a cooling target, a blast fan adapted to feed air for cooling, a duct adapted to make the air by the blast fan flow, and having an exhaust port opposed to the optical element, and a furry member provided to at least one of an inside wall and an end part of the duct.

According to this application example, due to the furry member provided to the inside wall and the end part, or the inside wall or the end part of the duct, it is possible to prevent eddying flows and so on from occurring in the air flowing inside the duct to reduce the wind noise, and at the same time, it is possible to cool the optical element. Thus, it is possible to realize the projector capable of effectively achieving the noise reduction of the duct.

### Application Example 2

In the projector according to the application example described above, it is preferable that the duct has a bend part, and the bend part is provided with the furry member.

According to this application example, since it is possible to suppress the eddying flows and so on apt to occur in the bend part to reduce the wind noise by providing the furry member to the bend part of the duct, it is possible to effectively achieve the noise reduction.

### Application Example 3

In the projector according to the application example described above, it is preferable that the duct has a branch part, and the branch part is provided with the furry member.

According to this application example, since it is possible to suppress the eddying flows and so on apt to occur in the branch part to reduce the wind noise by providing the furry member to the branch part of the duct, it is possible to effectively achieve the noise reduction.

### Application Example 4

In the projector according to the application example described above, it is preferable that the exhaust port is provided with the furry member.

According to this application example, since it is possible to suppress the eddying flows and so on apt to occur in the exhaust port to reduce the wind noise by providing the furry member to the exhaust port of the duct, it is possible to effectively achieve the noise reduction.

### Application Example 5

In the projector according to the application example described above, it is preferable that a tip part of the exhaust port is provided with the furry member.

According to this application example, since it is possible to suppress the eddying flows and so on apt to occur in the tip part of the exhaust port to reduce the wind noise by providing the furry member also to the tip part in addition to providing the furry member to the exhaust port, it is possible to more effectively achieve the noise reduction.

### Application Example 6

In the projector according to the application example described above, it is preferable that the optical element as the cooling target includes at least one of a light modulation element, a polarization conversion element, and a polarization plate.

According to this application example, it is possible to achieve the noise reduction of the duct, and in addition, it is possible to surely cool any of the light modulation element, the polarization conversion element and the polarization plate having a large amount of heat generation as the cooling target.

### Application Example 7

In the projector according to the application example described above, it is preferable that the furry member is formed by electrostatic flocking.

According to this application example, even if the duct extends to have a tubular shape, it is possible to surely and easily provide the furry member to the inside wall of the duct.

### BRIEF DESCRIPTION OF THE DRAWINGS

The invention will be described with reference to the accompanying drawings, wherein like numbers reference like elements.

FIG. 1 is a schematic diagram showing an overall configuration of an optical system of a projector according to an embodiment of the invention.

FIG. 2 is a schematic diagram showing a duct for cooling the optical system.

FIG. 3 is a plan view showing a cooling mechanism.

FIG. 4 is an A-A cross-sectional view in FIG. 3.

FIG. 5 is a B-B cross-sectional view in FIG. 3.

### DESCRIPTION OF AN EXEMPLARY EMBODIMENT

An embodiment of the invention will hereinafter be described in detail with reference to the drawings. It should be noted that the drawings used in the following description show characteristic parts in an enlarged manner for the sake of convenience in order to make the features easy to understand, and the dimensional ratios between the constituents and so on are different from actual ones.

### Embodiment

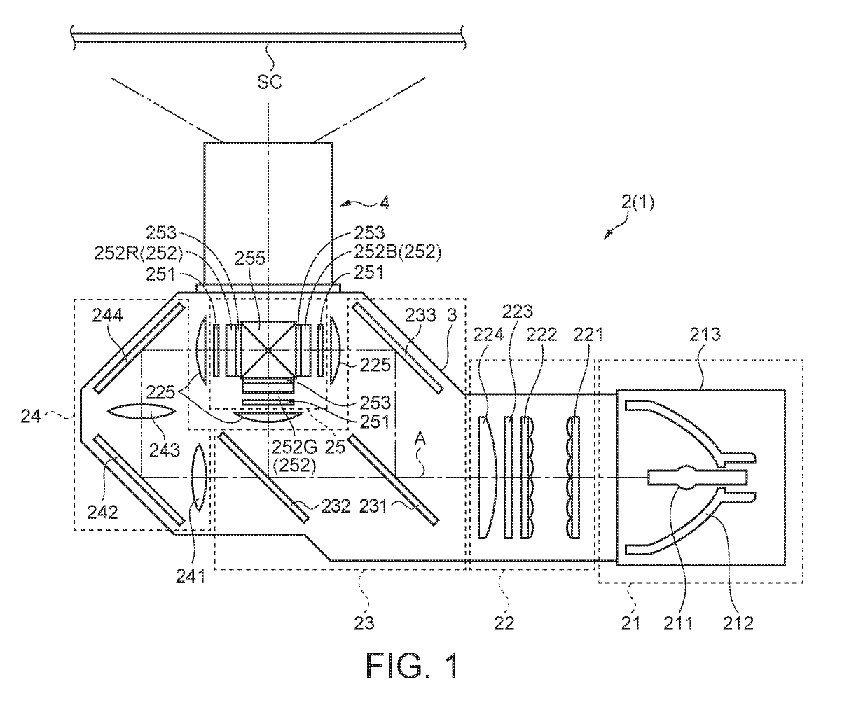

FIG. 1 is a schematic diagram showing an overall configuration of an optical system of a projector 1 according to the present embodiment.

The projector 1 according to the present embodiment will be described.

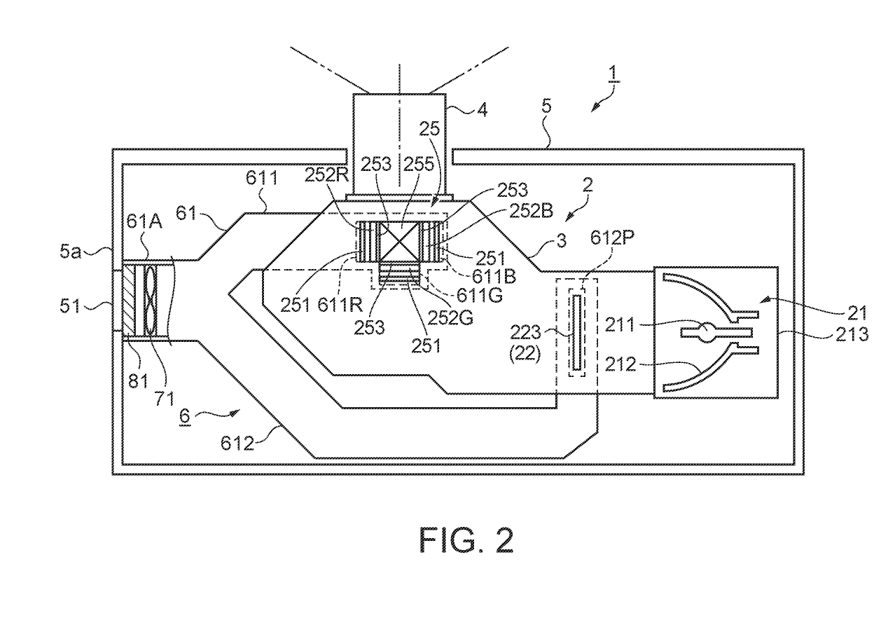

The projector 1 according to the present embodiment is a device for modulating light emitted from a light source device 21 based on image information to form image light, and then projecting the image light on a screen SC or the like in an enlarged manner. The projector 1 is provided with an exterior housing 5 (see FIG. 2) constituting an exterior. Further, inside the exterior housing 5, there are provided an optical unit 2, a cooling mechanism 6 (see FIG. 2), a power section (not shown), a circuit unit (not shown) including a control section (not shown) for controlling an operation of the projector 1, and so on.

The optical unit 2 is configured including a light source device 21, an illumination optical device 22, a color separation optical device 23, a relay optical device 24, an optical device 25 and a projection optical device 4.

The light source device 21 is housed in a housing 213 shaped like a box. The light source device 21 is provided with a light source lamp 211 of a discharge type as a light source, a reflector 212 and so on. The light source device 21 reflects light emitted by light emission of the light source lamp 211 with the reflector 212 to align the emission direction, and then emits the result toward the illumination optical device 22.

The illumination optical device 22 homogenizes the illuminance of the light emitted from the light source device 21 in a plane perpendicular to an illumination optical axis A. The illumination optical device 22 is provided with a first lens array 221, a second lens array 222, a polarization conversion element 223, and an overlapping lens 224. Further, the illumination optical device 22 is provided with three field lenses 225. The first lens array 221 and the second lens array 222 superimpose the light emitted from the light source device 21 on the surface of a light modulation element (a liquid crystal panel 252) described later in cooperation with the overlapping lens 224. The polarization conversion element 223 has a function of aligning the randomly polarized light emitted from the second lens array 222 into a substantially single kind of polarized light available to the liquid crystal panel 252. The field lenses 225 are respectively disposed in front of the three liquid crystal panels 252, and each convert partial light beams emitted from the second lens array 222 into light beams parallel to the center axis thereof.

The color separation optical device 23 is for separating the illumination light beam from the illumination optical device 22 into three colored light beams of red (R) light, green (G) light, and blue (B) light, and then guiding them to the three liquid crystal panels 252 corresponding respectively to the three colored light beams. The color separation optical device 23 is provided with two dichroic mirrors 231, 232 and a reflecting mirror 233.

The relay optical device 24 is for guiding the colored light beam (the R light in the present embodiment) separated by the color separation optical device 23 to the light modulation element (an R-light light modulation element in the present embodiment) while preventing the degradation of utilization efficiency of the light due to the diffusion and so on of the light caused by the fact that the length of the light path of the colored light beam separated by the color separation optical device 23 becomes longer than the lengths of the light paths of other light beams (the G light, the B light). The relay optical device 24 is provided with an incident side lens 241, a relay lens 243, and reflecting mirrors 242, 244. It should be noted that although it is assumed that the optical unit 2 of the present embodiment has the configuration in which the relay optical device 24 guides the R light, the configuration is not a limitation, but a configuration in which, for example, the relay optical device 24 guides the B light can also be adopted.

The optical device 25 is for modulating the colored light beams having entered the respective light modulation elements based on the image information (signal) to form optical images, combining the optical images of the respective colored light beams thus formed using a color combining optical device, and then emitting the optical images thus combined to the projection optical device 4 as the image light. The optical device 25 is provided with the three liquid crystal panels 252 constituting the light modulation elements, three incident side polarization plates 251, three emission side polarization plates 253, and a cross dichroic prism 255 as the color combining optical device.

Further, the three liquid crystal panels 252 are respectively constituted by an R-light liquid crystal panel 252R as the R-light light modulation element, a G-light liquid crystal panel 252G as a G-light light modulation element, and a B-light liquid crystal panel 252B as a B-light light modulation element. It should be noted that transmissive type liquid crystal panels are adopted as the three liquid crystal panels 252 constituting the light modulation element of the present embodiment. The cross dichroic prism 255 is formed to have a prismatic shape having a roughly square cross-sectional shape by bonding four prisms each having a triangular prismatic shape to each other.

Further, in the optical device 25, the three incident side polarization plate 251, the three liquid crystal panels 252, the three emission side polarization panels 253 and the cross dichroic prism 255 are integrally configured. In detail, the configuration is obtained by holding to fix the three emission side polarization plates 253, the three liquid crystal panels 252 and the three incident side polarization plates 251 corresponding to each other to the surfaces of incidence in three directions adjacent to each other of the cross dichroic prism 255 via a holding member (not shown). The cross dichroic prism 255 to which the incident side polarization plate 251, the liquid crystal panels 252 and the emission side polarization plates 253 are fixed is fixed while keeping the optical positional relationship with the optical component housing 3 via a base member not shown.

The projection optical device 4 has a function of performing zoom control of the image light entering the projection optical device 4, and a function of performing focus control, and is for projecting the image light formed by the optical device 25 on the screen SC in an enlarged manner.

The optical component housing 3 has the predetermined illumination optical axis A set inside, houses the optical devices 21 through 24 described above at predetermined positions with respect to the illumination optical axis A, and is fixed to the base member together with the cross dichroic prism 255.

It should be noted that the light source device 21 is not limited to the configuration using the light source lamp 211 of the discharge type, and it is also possible to use a semiconductor laser diode and a light emitting diode (LED). Further, the light modulation elements are not limited to the liquid crystal panels 252 of the transmissive type, but it is possible to use those using reflective type liquid crystal panels, or micromirror type devices such as those using digital micromirror devices (DMD).

FIG. 2 is a schematic diagram showing the cooling mechanism 6 for the optical system.

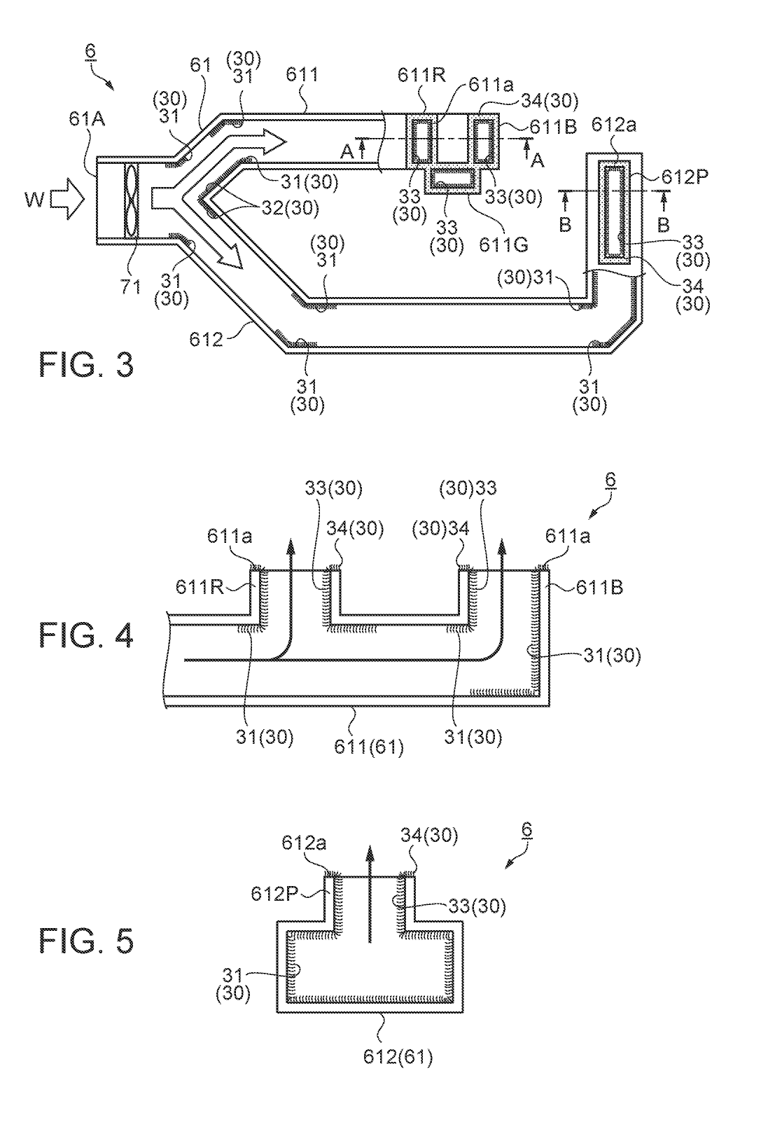

It should be noted that FIG. 2 shows the cooling mechanism 6 for cooling the optical device 25 and the illumination optical device 22. Further, FIG. 2 shows a cross-sectional view of a vicinity of a suction fan 71. FIG. 3 is a plan view showing the cooling mechanism 6. It should be noted that in FIG. 3, a part of a principal part is shown using a cross-sectional view to show an installation state of furry members 30 according to the invention. FIG. 4 is an A-A cross-sectional view in FIG. 3. In FIG. 4, the furry members 30 are disposed in ejection ports 611R, 611B as exhaust ports of a duct 61. FIG. 5 is a B-B cross-sectional view in FIG. 3. In FIG. 5, the furry members 30 are disposed in an ejection port 612P as the exhaust port of the duct 61.

A configuration of the cooling mechanism 6 will be described.

The cooling mechanism 6 of the present embodiment mainly cools the optical device 25 and the illumination optical device 22 constituting the optical unit 2. Specifically, in the optical device 25, the liquid crystal panels 252, the incident side polarization plates 251 and the emission side polarization plates 253 as a cooling target are cooled. Further, in the illumination optical device 22, there is cooled the polarization conversion element 223 as the cooling target.

It should be noted that in the present embodiment, the cooling mechanism 6 alone is described. However, the cooling mechanism is additionally provided with three cooling mechanisms not shown. Therefore, in the present embodiment, totally four cooling mechanisms are provided.

One of the three cooling mechanisms other than the cooling mechanism 6 is a cooling mechanism for cooling the power supply section.

Second one of the three cooling mechanisms is a cooling mechanism for cooling the light source device 21. It should be noted that this cooling mechanism cools the light source device 21 by suctioning the air (inside air) which has been ejected inside the exterior housing 5 due to the operation of the cooling mechanism 6 and the cooling mechanism for cooling the power supply section, and has thus been warmed.

Further, third one of the three cooling mechanisms is a cooling mechanism for discharging the inside air which has been ejected after drawing the heat, and has thus been warmed to the outside (the outside of the projector 1) of the exterior housing 5. By this cooling mechanism operating, cooling is achieved while drawing the heat of an IC (not shown) generating the heat in the circuit unit.

By the four cooling mechanisms described hereinabove operating, the inside of the projector 1 is appropriately cooled.

As shown in FIG. 2 and FIG. 3, the cooling mechanism 6 is roughly configured including the duct 61 and the suction fan 71 as a blast fan. Further, the duct 61 is formed in a state of extending to have a roughly rectangular cylindrical shape. Then, in the principal parts of an inside wall of the duct 61, there are disposed the furry members 30 for reducing the wind noise according to the invention.

It should be noted that the furry members 30 are each a member formed by attaching fibers (e.g., short fibers having a length of about 1.5 mm made of nylon or the like) to the object using an electrostatic flocking process as one of surface treatment technologies. In detail, the electrostatic flocking process is a processing method of applying an adhesive on a surface of the object to be provided with the furry member, then applying a high voltage of, for example, several tens of thousands of volts, to fly the short fibers using the electrostatic force to evenly and densely adhere to the surface of the object. It should be noted that as the material of the furry members, it is also possible to use synthetic fibers such as polyester, natural fibers such as silk or cotton, or functional fibers having heat resistance or the like besides nylon used in the present embodiment.

An intake port 61A on the intake side of the duct 61 is disposed so as to be opposed to an intake opening part 51 provided to a side surface 5a of the exterior housing 5. It should be noted that a filter 81 for covering the intake opening part 51 is disposed on the inside wall side of the intake opening part 51 so as to detachably be attached. The duct 61 is disposed so that the intake port 61A of the duct 61 covers the filter 81. It should be noted that the filter 81 has a dust removal function for cleaning the outer air by adhering dust included in the outside air when suctioning the outside air.

The suction fan 71 feeds the air (the outside air W) for cooling to the inside of the duct 61. The suction fan 71 is disposed in the vicinity of the intake port 61A of the duct 61. It should be noted that as the suction fan 71, there is adopted a sirocco fan in the present embodiment. In the sirocco fan, there is adopted a structure in which the air suctioned from a rotational axis direction is ejected toward the centrifugal direction due to the rotation. It should be noted that as the suction fan 71, it is also possible to adopt an axial fan having a structure in which the air suctioned from one of the rotational axis directions is ejected toward the other of the rotational axis directions.

The duct 61 on the posterior stage side of the suction fan 71 is branched into a first duct 611 and a second duct 612 in the middle of the duct 61.

The first duct 611 is a duct for cooling the optical device 25. As shown in FIG. 2 and FIG. 3, the first duct 611 reaches a lower side area of the optical device 25 via a lower side of the optical component housing 3, and is provided with three ejection ports 611R, 611G and 611B as the exhaust ports opening upward. In other words, the ejection ports 611R, 611G and 611B are opposed to the optical device 25.

It should be noted that the ejection port 611R is formed on the lower side of the R-light liquid crystal panel 252R, the incident side polarization plate 251 located in the anterior stage of the R-light liquid crystal panel 252R, and the emission side polarization plate 253 located in the posterior stage thereof. Similarly, the ejection port 611G is formed on the lower side of the G-light liquid crystal panel 252G, the incident side polarization plate 251 located in the anterior stage of the G-light liquid crystal panel 252G, and the emission side polarization plate 253 located in the posterior stage thereof. Similarly, the ejection port 611B is formed on the lower side of the B-light liquid crystal panel 252B, the incident side polarization plate 251 located in the anterior stage of the B-light liquid crystal panel 252B, and the emission side polarization plate 253 located in the posterior stage thereof. It should be noted that the base member (not shown) opposed to the three ejection ports 611R, 611G and 611B is provided with a penetrating opening part not shown.

The second duct 612 is a duct for cooling the polarization conversion element 223. As shown in FIG. 2 and FIG. 3, the second duct 612 reaches a side surface area of the polarization conversion element 223 via a lower side of a side surface of the optical component housing 3, and is provided with one ejection port 612P as the exhaust port opening upward. In other words, the ejection port 612P is opposed to the polarization conversion element 223. The lower surface of the optical component housing 3 opposed to the ejection port 612P is provided with a penetrating opening part not shown.

As shown in FIG. 3 through FIG. 5, the furry member 30 is disposed on an inside wall in each of bending areas (bend sections) of the first duct 611, and bending areas of the second duct 612. It should be noted that the furry members 30 in the bending areas are hereinafter referred to in particular as furry members 31. As shown in FIG. 3, the furry members 30 are also disposed on an inside wall of an area (a branch section) where the duct 61 is branched into the first duct 611 and the second duct 612. It should be noted that the furry members in the branched areas are hereinafter referred to in particular as furry members 32.

As shown in FIG. 4, the furry members 30 are also disposed on the inside walls in each of areas of the ejection ports 611R, 611G and 611B as the exhaust ports. Further, as shown in FIG. 5, the furry members 30 are also disposed on the inside walls in an area of the ejection port 612P as the exhaust port. It should be noted that the furry members 30 in the areas of the ejection ports 611R, 611G, 611B and 612P are hereinafter referred to in particular as furry members 33.

As shown in FIG. 3 through FIG. 5, the furry members 30 are also installed in tip parts 611a of the ejection ports 611R, 611G and 611B as the exhaust ports, and a tip part 612a of the ejection port 612P as the exhaust port. It should be noted that the furry members 30 in end surface areas of the tip parts 611a, 612a of the ejection ports 611R, 611G, 611B and 612P are hereinafter referred to in particular as furry members 34.

An operation of the cooling mechanism 6 will be described.

By the suction fan 71 rotating, the outside air W in the outside of the exterior housing 5 is suctioned from the intake port 61A inside the duct 61 via the intake opening part 51. On this occasion, the outside air W passes through the filter 81 installed on the inside wall side of the intake opening part 51. By the outside air W passing through the filter 81, the dust included in the outside air W is cleaned. Therefore, the outside air W thus cleaned flows inside the duct 61.

One of the outside air W having passed through the suction fan 71 is branched and then inflows into the first duct 611. The outside air W having flowed inside the first duct 611 is ejected upward from the three ejection ports 611R, 611G and 611B. The outside air W having ejected from the ejection port 611R blows against the R-light liquid crystal panel 252R, the incident side polarization plate 251 and the emission side polarization plate 253 of the optical device 25 located above, and then blows upward. Thus, the outside air W draws the heat generated in the R-light liquid crystal panel 252R, the incident side polarization plate 251 and the emission side polarization plate 253 to thereby cool the R-light liquid crystal panel 252R, the incident side polarization plate 251 and the emission side polarization plate 253. The outside air W ejected from the other ejection ports 611G, 611B also acts similarly to the outside air W ejected from the ejection port 611R, and thus, the optical device 25 is cooled by the outside air W flowing through the first duct 611.

Here, the furry members 31 are disposed in the bending inside wall areas of the first duct 611. Further, the furry member 32 is also disposed in the inside wall area where the duct 61 is branched into the first duct 611 and the second duct 612. By disposing the furry members 31, 32 in the bending inside wall areas and the branching inside wall area as described above, it is possible to decrease eddying flows and so on which become apt to occur in the bending area and the branching area in the case in which the outside air W flows inside the first duct 611.

Further, the furry members 33 are disposed in the inside wall areas of the three ejection ports 611R, 611G and 611B to be the exhaust ports of the first duct 611. By providing the furry members 33 to the exhaust ports in such a manner, it is possible to decrease the eddying flows and so on which become apt to occur in the case of ejecting the outside air W from the ejection ports 611R, 611G and 611B of the first duct 611 to the outside. Further, in the present embodiment, by further providing the furry members 34 also to the tip parts 611a of the ejection ports 611R, 611G and 611B, the eddying flows and so on are further decreased.

The other of the outside air W having passed through the suction fan 71 is branched and then inflows into the second duct 612. The outside air W having flowed inside the second duct 612 is ejected upward from the ejection port 612P. The outside air W having been ejected from the ejection port 612P blows against the polarization conversion element 223 of the illumination optical device 22 located above, and then blows upward from the opening part (not shown) provided to the optical component housing 3 opposed above the polarization conversion element 223. Thus, the outside air W draws the heat generated in the polarization conversion element 223 to thereby cool the polarization conversion element 223.

Here, as described above, the furry members 31 are disposed in the bending inside wall areas of the second duct 612. Further, the furry member 32 is also disposed in the inside wall area where the duct 61 is branched into the first duct 611 and the second duct 612. By disposing the furry members 31, 32 in the bending inside wall areas and the branching inside wall area as described above, it is possible to decrease the eddying flows and so on which become apt to occur in the bending area and the branching area in the case in which the outside air W flows inside the second duct 612.

Further, the furry members 33 are disposed in the inside wall areas of the one ejection port 612P to be the exhaust port of the second duct 612. By providing the furry members 33 to the exhaust port in such a manner, it is possible to decrease the eddying flows and so on which become apt to occur in the case of ejecting the outside air W from the ejection port 612P of the second duct 612 to the outside. Further, in the present embodiment, by further providing the furry members 34 also to the tip part 612a of the ejection port 612P, the eddying flows and so on are further decreased.

It should be noted that the three cooling mechanisms described above other than the cooling mechanism 6 are also provided with blast fans and ducts, and the eddying flows and so on can similarly be decreased by disposing the furry members 30 in bending inside wall areas, branching wall area, inside wall areas and areas of tip parts of ejection ports to be exhaust ports of the ducts as described above.

According to the embodiment described above, the following advantages can be obtained.

In the projector 1 according to the present embodiment, since it is possible to suppress the eddying flows and so on apt to occur in the bend parts to reduce the wind noise by providing the furry members 31 to the bend parts of the duct 61, it is possible to effectively achieve the noise reduction of the duct 61.

In the projector 1 according to the present embodiment, since it is possible to suppress the eddying flows and so on apt to occur in the branch part to reduce the wind noise by providing the furry members 32 to the branch part of the duct 61, it is possible to effectively achieve the noise reduction of the duct 61.

In the projector 1 according to the present embodiment, since it is possible to suppress the eddying flows and so on apt to occur in the exhaust ports to reduce the wind noise by providing the furry members 33 to the ejection ports 611P, 611G, 611B and 612P as the exhaust ports of the duct 61, it is possible to effectively achieve the noise reduction of the duct 61.

In the projector 1 according to the present embodiment, since the furry members 34 are provided to the tip parts 611a, 612a of the ejection ports 611R, 611G, 611B and 612P of the duct 61, it is possible to further suppress the eddying flows and so on to reduce the wind noise. Therefore, it is possible to more effectively achieve the noise reduction of the duct 61.

In the projector 1 according to the present embodiment, the cooling mechanism 6 makes it possible to achieve the noise reduction of the duct 61, and in addition, makes it possible to surely cool the light modulation elements (the liquid crystal panels 252), the polarization conversion element 223 and the polarization plates (the incident side polarization plates 251, the emission side polarization plates 253) having the large amount of heat generation as the cooling target.

In the projector 1 according to the present embodiment, since the furry members 30 are formed by the electrostatic flocking, even if the duct 61 extends to have a tubular shape, it is possible to surely and easily form (dispose) the furry members 30 on the inside wall of the duct 61.

According to the projector 1 of the present embodiment, since it is possible to achieve the noise reduction of the duct 61 by providing the furry members 30 (31, 32, 33, and 34) to the principal parts of the duct 61, it is possible to realize the projector capable of achieving the noise reduction. In addition, it is possible to realize the projector capable of appropriately performing the cooling of the optical element.

It should be noted that the invention is not limited to the embodiment described above, but can be implemented with a variety of modifications or improvements added within the scope or the spirit of the invention. Some modified examples will be described below.

In the projector 1 according to the embodiment described above, the furry members 30 are provided to the principal parts (the bend parts, the branch part, and the ejection ports). However, this is not a limitation, and it is also possible to reduce the noise due to vibrations by disposing the furry members 30 in the inside wall areas and the areas of the tip parts of the intake port 61A, the inside wall areas of the duct 61 where the suction fan 71 is disposed, and so on to achieve the reduction of the wind noise and at the same time to prevent gaps.

In the projector 1 according to the embodiment described above, the furry members 30 are provided to the principal parts (the bend parts, the branch part, and the ejection ports). However, this is not a limitation, and it is also possible to dispose the furry members 30 in the entire area of the inside wall of the duct 61.

In the projector 1 according to the embodiment described above, the cooling mechanism 6 cools the optical device 25 and the illumination optical device 22 (the polarization conversion element 223). However, this is not a limitation, and it is also possible to arbitrarily change the optical element cooled by the duct depending on the layout and so on of the constituent sections (e.g., the optical unit, the power supply section, and the circuit unit) inside the exterior housing.

In the projector 1 according to the embodiment described above, the cooling mechanism 6 cools the optical device 25 and the illumination optical device 22 (the polarization conversion element 223). However, this is not a limitation, and it is also possible to cool the optical elements other than the optical device 25 and the illumination optical device 22. Further, it is also possible to adopt a configuration of making the ejection port of the duct face to a fin which is directly or indirectly connected to a heat generating member to conduct the heat and perform heat radiation, and making the outside air W blow against the fin to thereby cool the heat generating member. As an example of such a fin, there is cited a radiator fin constituting a wavelength conversion device (an optical element) excited by light in a first wavelength band to thereby generate light in a second wavelength band different from the first wavelength band.

The projector 1 according to the embodiment described above is constituted by the four cooling mechanisms, but can also be constituted by more cooling mechanisms or less cooling mechanisms.

The entire disclosure of Japanese Patent Application No. 2017-239344, filed on Dec. 14, 2017 is expressly incorporated by reference herein.

What is claimed is:

1. A projector adapted to modulate light emitted from a light source based on image information and project the light modulated, comprising:
an optical element as a cooling target;
a blast fan adapted to feed air for cooling;
a duct adapted to make the air by the blast fan flow, and having an exhaust port opposed to the optical element; and
a furry member provided to at least one of an inside wall and an end part of the duct.

2. The projector according to claim 1, wherein
the duct has a bend part, and
the bend part is provided with the furry member.

3. The projector according to claim 1, wherein
the duct has a branch part, and
the branch part is provided with the furry member.

4. The projector according to claim 1, wherein
the exhaust port is provided with the furry member.

5. The projector according to claim 1, wherein
a tip part of the exhaust port is provided with the furry member.

6. The projector according to claim 1, wherein
the optical element as the cooling target includes at least one of a light modulation element, a polarization conversion element, and a polarization plate.

7. The projector according to claim 1, wherein
the furry member is formed by electrostatic flocking.
